(19) United States
(12) Patent Application Publication
(10) Pub. No.: US 2017/0186346 A1
(43) Pub. Date: Jun. 29, 2017

(54) ADAPTABLE TENSIONED-FABRIC FRAMING SYSTEM

(71) Applicant: M. Rogers Design, Inc., Glenview, IL (US)

(72) Inventors: Chadwick J. McNeal, Northfield, IL (US); Michele R. Pasik, Homer Glen, IL (US)

(21) Appl. No.: 15/379,921

(22) Filed: Dec. 15, 2016

Related U.S. Application Data
(60) Provisional application No. 62/272,227, filed on Dec. 29, 2015.

(51) Int. Cl. G09F 15/00; G09F 7/18

(52) U.S. Cl. CPC G09F 15/0025; G09F 7/18; G09F 2007/1821; G09F 2007/1843; G09F 2007/1847; G09F 2007/1886; G09F 2015/0093

(57) ABSTRACT

A support system for tensioned fabric is provided comprising two or more elongated frame members, each having an outer surface with a plurality of spaced-apart, axially-extending recesses. At least one elongated clip is associated with each elongated frame member. Each clip has a first segment configured to be received in one of the axially-extending recesses of its associated elongated frame member and a second segment configured to hold an edge of the tensioned fabric. Each elongated clip is configured to be slidably received in its associated axially-extending recess in the frame member. To this end, the first segment of each elongated clip has a cross-sectional shape complementary to a cross-sectional shape of the axially-extending recesses. In another aspect, the second segment of each clip comprises at least one pair of first and second spaced apart planar portions defining a track or slot for receiving the edge of the tensioned fabric.

### BACKGROUND

The present application relates to a framing system suitable for use with large format printed sheet media, and more particularly to an adaptable tensioned fabric framing system that is changeable in configuration and is also easily assembled and disassembled for mounting printed sheet media, such as silicone edged graphics (SEG).

With the advent of large format printing, the use of large scale, custom printed tensioned fabric has become commonplace in environments such as trade show displays, event banners and signs, point of purchase displays and the like. In many instances, the tensioned fabric graphics are only temporarily displayed in a particular location, or the tensioned fabric may be changed from location to location. Thus there is a need for a framing system for mounting such tensioned fabric graphics that is re-usable, easily changeable in its configuration and dimensions, and can be easily assembled and disassembled to facilitate its installation, storage and transport from location to location.

By way of the present disclosure, an adaptable framing system is provided which permits customized configuration of the framing system, as well as subsequent reconfiguration, with interchangeable component parts, for supporting tensioned fabrics.

### SUMMARY

There are several aspects of the framing system described herein that may be employed alone or in combination with other aspects, and the description of these aspects below in any particular combination is not intended to preclude there use in other combinations.

In a first aspect, a support system for tensioned fabric is provided comprising two or more elongated frame members, each having an outer surface with a plurality of spaced-apart, axially-extending recesses. At least one elongated clip is associated with each elongated frame member. Each clip has a first segment configured to be received in one of the axially-extending recesses of its associated elongated frame member and a second segment configured to hold an edge of the tensioned fabric.

In a second aspect, each elongated clip is configured to be slidably received in its associated axially-extending recess in the frame member. To this end, the first segment of each elongated clip has a cross-sectional shape complementary to a cross-sectional shape of the axially-extending recesses. In one embodiment, the first segment of the clip comprises a substantially cylindrical portion connected to the second segment of the clip by a substantially planar portion, with the cylindrical portion being enlarged relative to the planar portion.

In another aspect, the second segment of each clip comprises at least one pair of first and second spaced apart planar portions defining a track or slot for receiving the edge of the tensioned fabric. Alternatively, the second segment of each clip comprises two or more pairs of spaced apart planar portions that define tracks or slots for receiving the edges of tensioned fabric. The tracks or slots defined by the two or more pairs can be coplanar, parallel to each other, or perpendicular to each other.

These aspects, as well as others, will become apparent upon reference to the accompanying drawings and following detailed description.

### BRIEF DESCRIPTION OF THE DRAWINGS

FIG. 1 is a perspective view of an adaptable framing system assembled in an exemplary configuration and comprising elongated frame members, elongated clips associated with the frame members, and tensioned fabric held by the clips.

FIG. 2 is a perspective view of an elongated frame member in accordance with the present invention.

FIG. 3 is and end view of the frame member of FIG. 2, an end view from the opposite end being identical.

FIG. 4 is front side view of the frame member of FIG. 2, side views from the left, right and rear being identical.

FIG. 5 is a perspective view of a first embodiment of a clip having two vertical tracks in accordance with the present invention.

FIG. 6 is an end view of the clip of FIG. 5, an end view from the opposite end being identical.

FIG. 7 is a top view of the clip of FIG. 5.

FIG. 8 is a bottom view of the clip of FIG. 5.

FIG. 9 is a side view of the clip of FIG. 5 taken from the left side of FIG. 6, a side view from the right side being identical.

FIG. 10 is a perspective view of a second embodiment of a clip having two horizontal tracks in accordance with the present invention.

FIG. 11 is an end view of the clip of FIG. 10, an end view from the opposite end being identical.

FIG. 12 is a top view of the clip of FIG. 10.

FIG. 13 is a bottom view of the clip of FIG. 10.

FIG. 14 is a side view of the clip of FIG. 10 taken from the left side of FIG. 11, a side view from the right side being identical.

FIG. 15 is a perspective view of a third embodiment of a clip having a single vertical track in accordance with the present invention.

FIG. 16 is an end view of the clip of FIG. 15, an end view from the opposite end being identical.

FIG. 17 is a top view of the clip of FIG. 15.

FIG. 18 is a bottom view of the clip of FIG. 15.

FIG. 19 is a side view of the clip of FIG. 15 taken from the left side of FIG. 16.

FIG. 20 is a side view of the clip of FIG. 15 taken from the right side of FIG. 16.

FIG. 21 is a perspective view of a fourth embodiment of a clip having a single horizontal track in accordance with the present invention.

FIG. 22 is an end view of the clip of FIG. 21, an end view from the opposite end being identical.

FIG. 23 is a top view of the clip of FIG. 21.

FIG. 24 is a bottom view of the clip of FIG. 21.

FIG. 25 is a side view of the clip of FIG. 21 taken from the left side of FIG. 22.

FIG. 26 is a side view of the clip of FIG. 21 taken from the right side of FIG. 22.

FIG. 27 is a perspective view of a fifth embodiment of a clip having a single horizontal track and a single vertical track in accordance with the present invention.

FIG. 28 is an end view of the clip of FIG. 27, an end view from the opposite end being identical.

FIG. 29 is a top view of the clip of FIG. 27.

FIG. 30 is a bottom view of the clip of FIG. 27.

FIG. 31 is a side view of the clip of FIG. 27 taken from the left side of FIG. 28.

FIG. 32 is a side view of the clip of FIG. 27 taken from the right side of FIG. 28.

FIG. 33 is a perspective view of a joiner bar for interconnecting two elongated frame members in accordance with the present invention.

FIG. 34 is an end view of the joiner bar of FIG. 33, and end view from the opposite end being identical.

FIG. 35 is a top view of the joiner bar of FIG. 33, a bottom view being identical.

FIG. 36 is a side view of the joiner bar of FIG. 33, a side view from the opposite side being identical.

FIG. 37 is a perspective view of an end cap for the exposed end of an elongated frame member of the present invention.

FIG. 38 is a perspective view showing an elongated frame member having a tensioned fabric secured thereto by means of a joiner bar.

### DETAILED DESCRIPTION

A more detailed description of an adaptable framing system in accordance with the present disclosure is set forth below. It should be understood that the description below is intended to be exemplary, and not exhaustive, of all possible variations or applications. Thus, the scope of the disclosure is not intended to be limiting, and should be understood to encompass variations or embodiments that would occur to persons of ordinary skill.

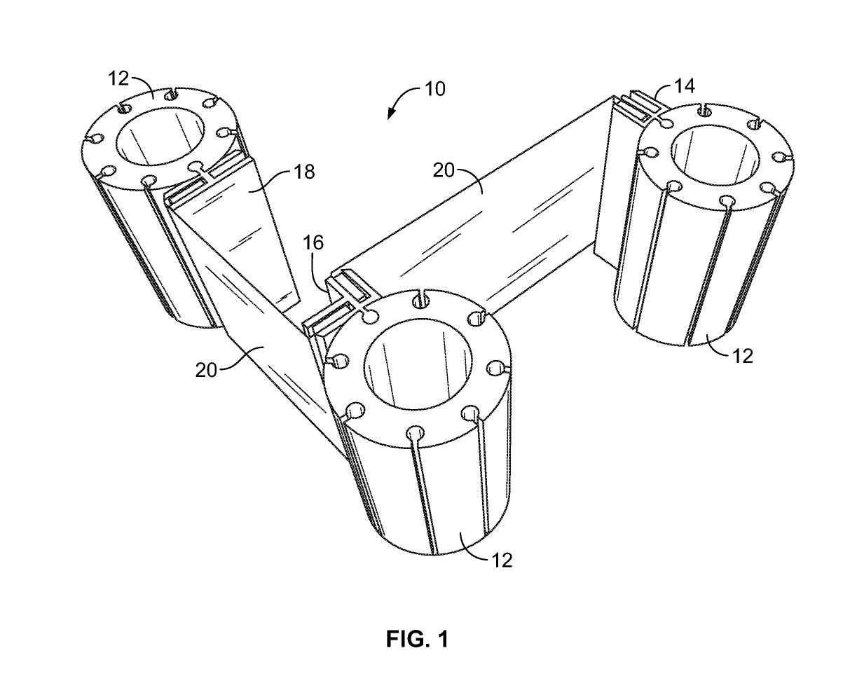

Turning to FIG. 1, there is seen a perspective view of an adaptable framing system, generally designated 10, incorporating the basic elements of the present invention. It will be appreciated that the configuration shown in FIG. 1 is for exemplary purposes only, and that an unlimited number of different configurations may be obtained using various combinations of these elements. These elements include elongated frame members 12, three different embodiments of elongated clips 14, 16, and 18, and sheets of tensioned fabric 20. Each of these elements, as well as others that may be used in combination therewith, are described in detail below.

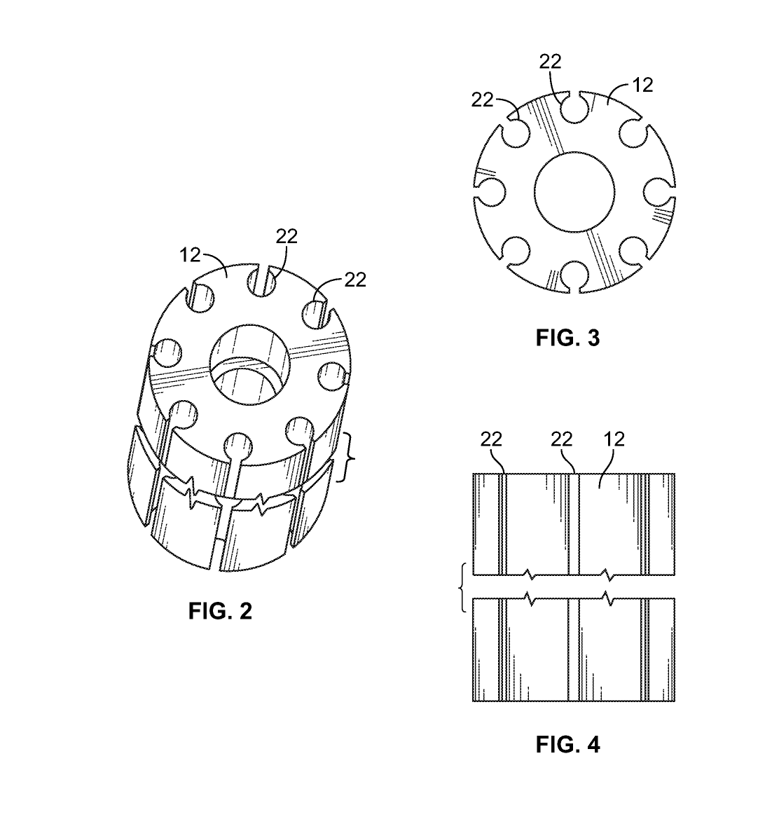

FIGS. 2-4 illustrate an elongated frame member 12. The elongated frame member 12, as illustrated, has a round profile, although other profiles may be used (such as an equilateral polygon having at least the number of sides corresponding to the number of clips to be associated therewith).

Each frame member 12 has a number of longitudinally-extending recesses or keyholes 22 equally spaced about its circumference (eight shown, spaced at 45°) configured so that the clips, such as clips 14, 16 and 18, can be mounted thereto. The recesses 22 have a narrow opening and a larger interior portion.

The frame members 12 are preferably made by extrusion of a durable, rigid material, such as anodized aluminum. The frame members 12 have a hollow interior and a wall thickness sufficient to ensure that the keyhole channels 22 have minimal distortion, so as to allow the clips and other insert materials to fit without issue. The surfaces of the frame members 12 may be provided with marks, or a series of circumferentially-spaced marks (as shown in FIG. 3), that provide a visual reference for orienting the frame members 12 during assembly of the frame system 10.

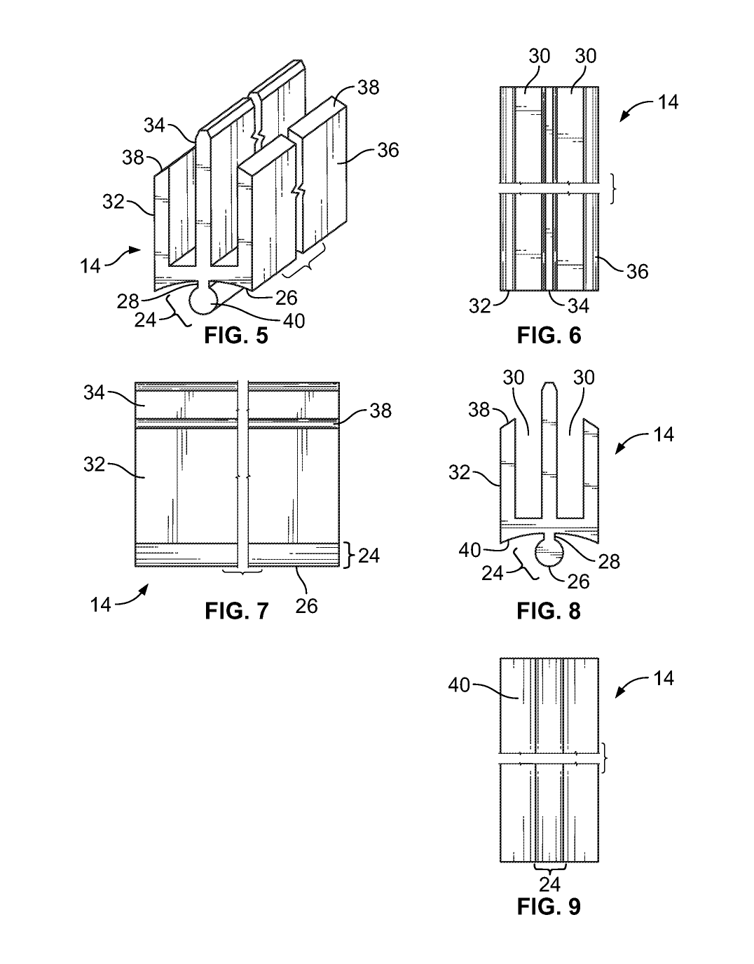

FIGS. 5-9 illustrate a first embodiment of an elongated clip 14 configured to be slidably mounted in one of the keyholes 22 of an associated frame member 12. To this end, the clip 14 includes a first segment 24 that has a cross-sectional shape that is complementary to the cross-sectional shape of the keyholes 22. As illustrated, this comprises a substantially cylindrical portion 26 and a narrower, substantially planar portion 28. This aspect of the clip 14 is common to the different clip embodiments described below that are to be used with the frame members 12.

The clip 14 has two vertical tracks or slots 30, that is, the tracks/slots 30 extend outwardly from the clip 14 in a direction generally perpendicular to the surface of the frame member 12. The clip 14 has spaced-apart, generally parallel, planar portions 32, 34 and 36 that define the slots 30, with the central planar portion 34 being wider (i.e., extending farther outwardly) than the other two portions 32 and 36. This helps to ensure that fabric 20, when inserted in the track/slot 30 under tension, forms a squared corner. The outer planar portions 32, 36 preferably have beveled ends 38, which also help to insure clean graphic visuals when the fabric 20 is under tension. The spacing between the planar portions 32, 34, 36 corresponds to the “brand standard” channel specifications for SEG fabrics to insure that the silicone bead formed on the edges of such fabrics is securely received therein.

The clip 14 is preferably formed with a bottom wall 40 that is shaped to correspond to the other surface of the associated frame member. In the illustrated clip 14, the bottom wall 40 has an arcuate configuration. This aspect of the clip 14 is also common to the different clip embodiments described below that are to be used with the frame members 12.

The clip 14 is preferably an extruded from a plastic polymer, as are the other embodiments of clips that are described herein.

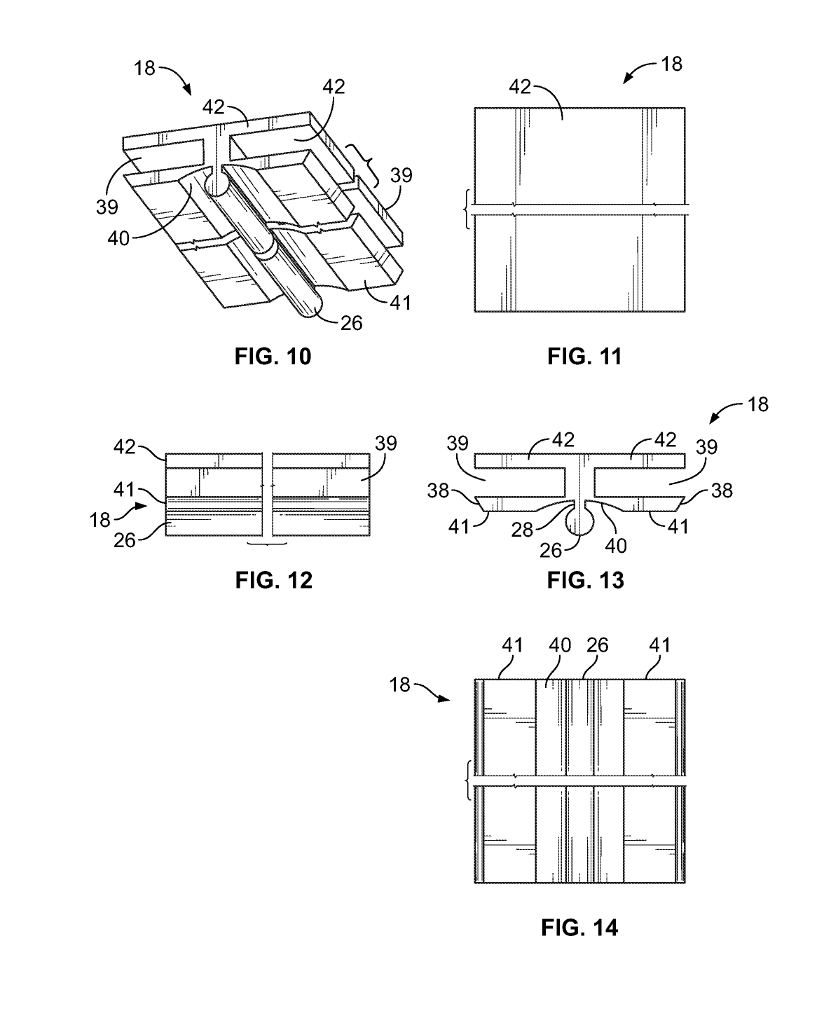

FIGS. 10-14 illustrate a second embodiment of an elongated clip 18. Clip 18 differs from clip 14 in that instead of having “vertical” tracks or slots, clip 18 comprises two horizontal tracks or slots 39, that is, the tracks/slots 39 are co-planar and extend in a direction generally tangential to the surface of the frame member 12. Spaced-apart planar portions 41, 42 define each horizontal slot, which open in opposite directions, with the spacing therebetween corresponding to the brand standard channel specifications for SEG fabrics. Elements of clip 18, as well as of the other clip configurations described herein, that are in common with clip 14 will not be described separately. However, such common elements will be identified in the drawings by common reference numerals.

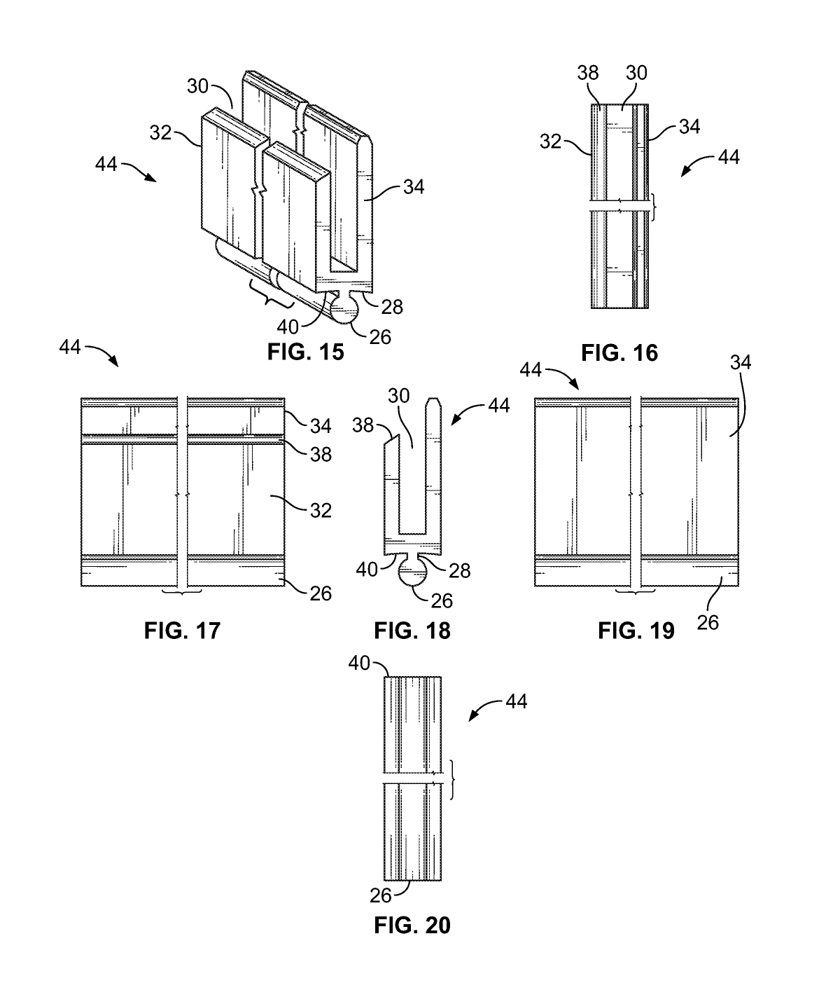

FIGS. 15-20 illustrate a third embodiment of a clip, generally designated 44. Clip 44 differs from clip 14 in that clip 44 includes only a single vertical track or slot 30, with spaced-apart planar portions 32, 34.

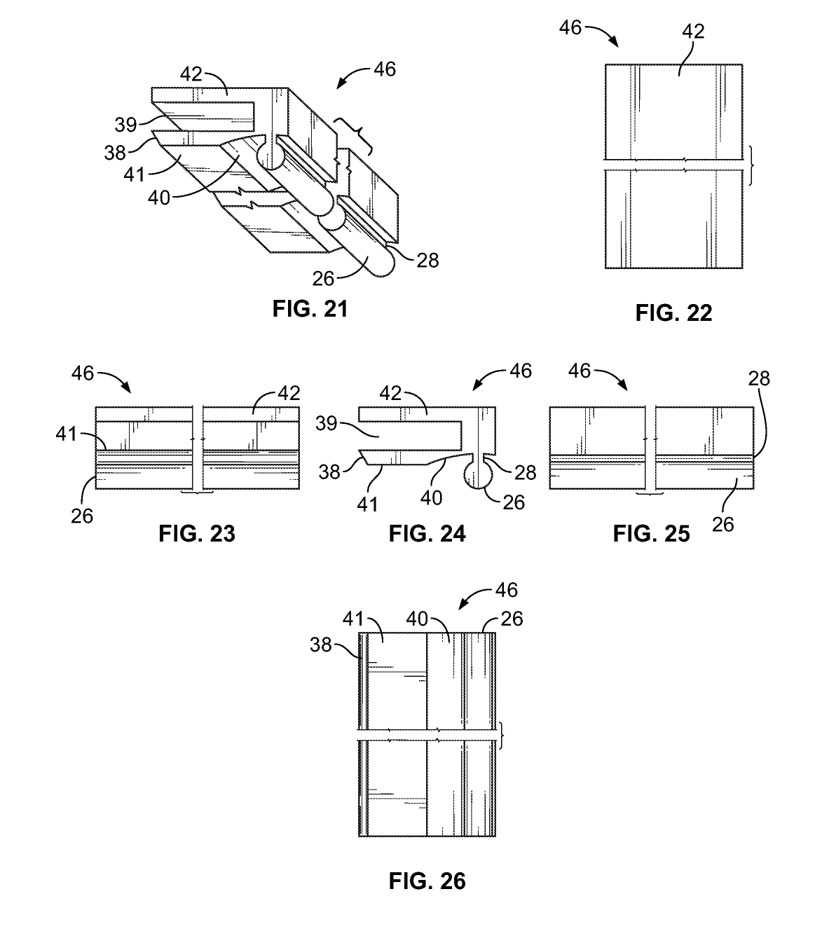

FIGS. 21-26 illustrate a fourth embodiment of a clip, generally designated 46. Clip 46 differs from clip 18 in that clip 44 includes only a single horizontal track or slot 39 defined by spaced-apart planar portions 41, 42.

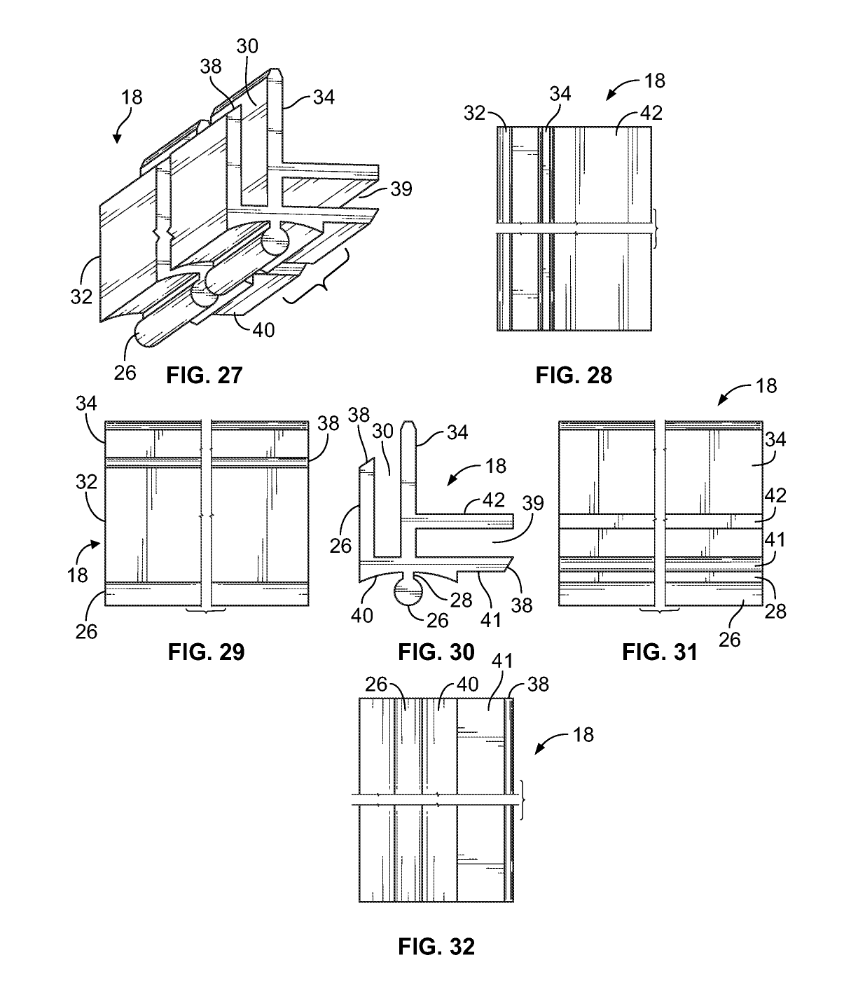

FIGS. 27-32 illustrate a fifth embodiment of a clip 18. Clip 18 is a combination of clip 44 and clip 46, in that clip 18 comprises a single vertical track or slot 30 and a single horizontal track or slot 39.

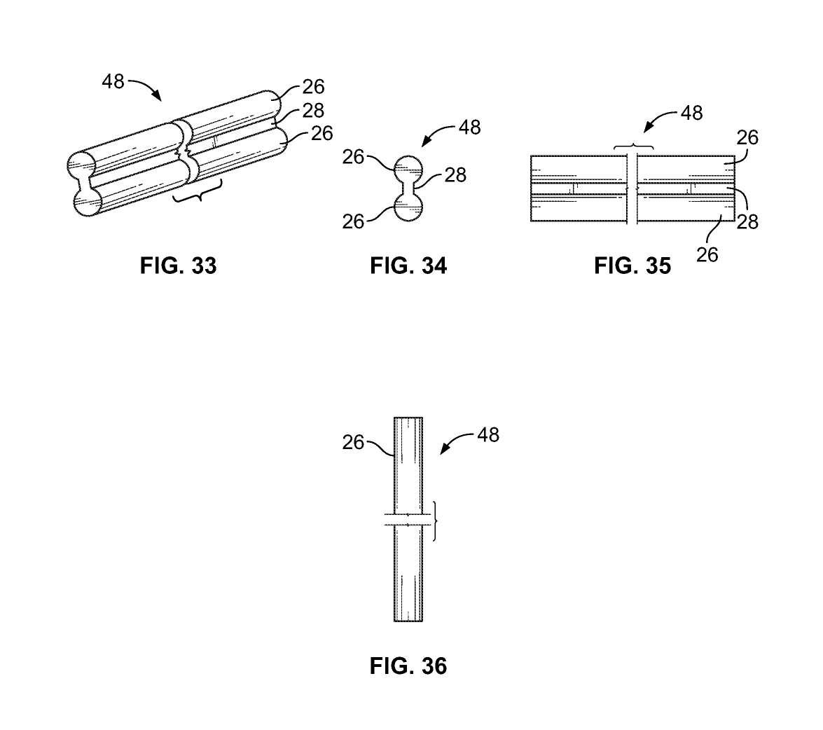

FIGS. 33-36 illustrate a joiner or slider bar, generally designated 48. The joiner bar 48 comprises opposed first segments 24, each having a cross-sectional shape that is complementary to the cross-sectional shape of the keyholes 22 of the frame members 12. As illustrated, the joiner bar comprises two substantially cylindrical portions 26 joined by a narrower, substantially planar portion 28. A joiner bar 48 may be used to join one frame member to another. Alternatively, a joiner bar may form the edge of a fabric sheet 20, such that the fabric sheet 20 may be directly secured a frame member 12, as shown in FIG. 38, without the use of a clip, such as the clips 14, 16, 18, 44 and 46, described above. The joiner bar 48 may be extruded from either a plastic polymer or aluminum.

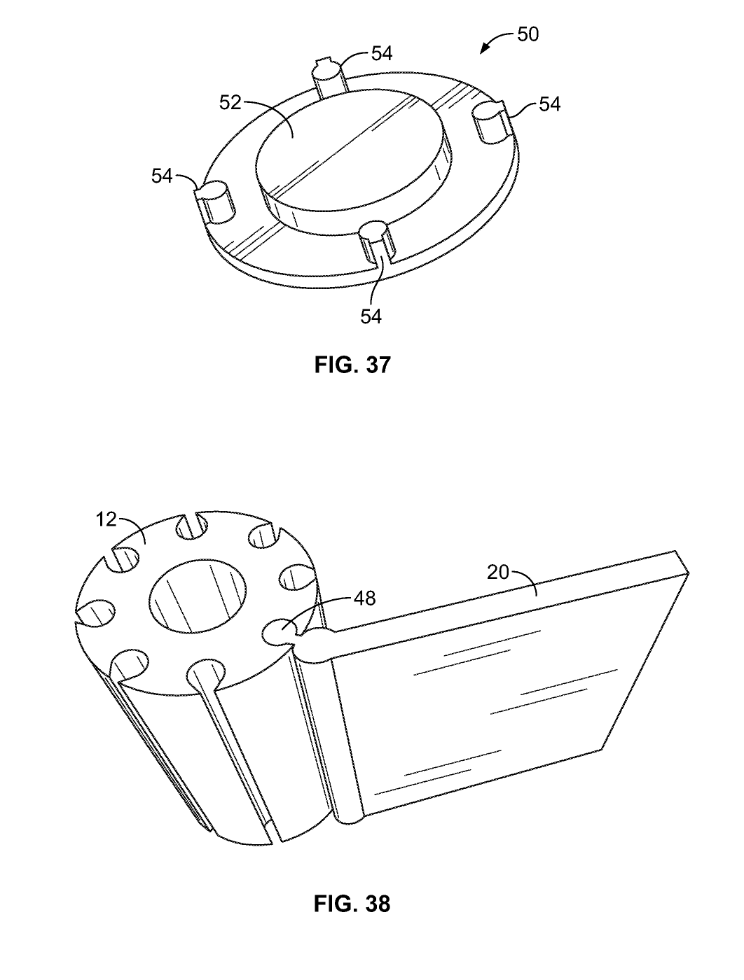

FIG. 37 illustrates an end cap 50 for closing the exposed ends of a frame member 12. The end cap 50 has a raised central portion 52 sized to be received in the hollow interior of the frame member 12. A plurality of raised plugs 54 configures to be received in the ends of the keyhole channels 22 in the frame member 12.

As can be appreciated, the frame members, clips and associated tensioned fabric can be combined in in a limitless number of ways to create a desired configuration. While the system has been described in the context of an exemplary assembly, there is no intent to limit the invention to the same. Instead, it is intended to include any modifications or revisions within the apparent to one of ordinary skill in the art. For example, while the frame members and the associated clips have been depicted as having a generally straight elongated configuration, they could also be curved or otherwise non-linear without departing from the invention.

1. A support system for tensioned fabric comprising:
a) A plurality of elongated frame members, each frame member having an outer surface with a plurality of spaced-apart axially-extending recesses;
b) At least one elongated clip associated with each elongated frame member, each clip having a first segment configured to be received in one of the axially-extending recesses of its associated elongated frame member and a second segment configured to hold an edge of the tensioned fabric.

2. The tensioned-fabric support system of claim 1 wherein the elongated clip is configured to be selectively slidably received in one of the axially-extending recesses in the elongated frame member.

3. The tensioned-fabric support system of claim 1 wherein the first segment of the elongated clip has a cross-sectional shape complementary to a cross-sectional shape of the axially-extending recess.

4. The tensioned-fabric support system of claim 3 wherein the first segment of the clip comprises a substantially cylindrical portion connected to the second segment of the clip by a substantially planar portion.

5. The tensioned-fabric support system of claim 1 wherein the elongated frame member has a hollow interior.

6. The tensioned-fabric support system of claim 1 wherein the second segment of the clip comprises at least one pair of first and second spaced-apart planar portions defining a track for receiving the edge of the tensioned fabric.

7, The tensioned-fabric support system of claim 1 wherein the second segment of the clip comprises a plurality of pairs of first and second spaced-apart planar portions, each pair defining a track for receiving the edge of the tensioned fabric.

8. The tensioned-fabric support system of claim 7 wherein the tracks defined by the plurality of pairs of first and second spaced-apart planar portions are coplanar.

9. The tensioned-fabric support system of claim 7 wherein the tracks defined by the plurality of pairs of first and second spaced-apart planar portions are parallel to each other.

10. The tensioned-fabric support system of claim 7 wherein the tracks defined by the plurality of pairs of first and second spaced-apart planar portions are perpendicular to each other.

11. The tensioned-fabric support system of any of claims 6-10 further comprising at least one fabric panel having opposed edges, a reinforcement member being associated with at least two of the opposed edges, the reinforcement members being configured to be received in the tracks in the second segment of the clip.
